(19) United States
(12) Patent Application Publication
(10) Pub. No.: US 2009/0160138 A1
(43) Pub. Date: Jun. 25, 2009

(54) Tool holder for a machine tool, in particular for a hand-held power tool

(76) Inventor: Ulrich Bohne, Kohlberg (DE)

Correspondence Address: MICHAEL J. STRIKER, 103 EAST NECK ROAD, HUNTINGTON, NY, 11743, US

(21) Appl. No.: 12/300,599

(22) PCT Filed: Dec. 13, 2007
(86) PCT No.: PCT/EP07/63857

§ 371 Date: Nov. 12, 2008

(30) Foreign Application Priority Data
Feb. 1, 2007 (DE) 10 2007 005 033.1

(51) Int. Cl. B23B 31/107

(52) U.S. Cl. 279/30

(57) ABSTRACT

A tool holder for a machine tool has a tool holder element in which an insertion tool is insertable and lockable, a locking device for locking the insertion tool in said tool holder element and including a locking element displaceable between a release position and a locking position in which the insertion tool is locked in the tool holder, a blocking element held in the tool holder element and displaceable by the insertion tool, the blocking element inhibiting a motion of the locking element in a locking position, a control element which displaces the blocking element and located on the tool holder, which in a first phase when the control element moves between the release position and the locking position in a control position in which it acts on the blocking element, and in a second phase the control element is in a non-operational position, the control element is configured so that it performs an axial motion in the control position and it performs a radial motion to move it into a non-operational position.

The present invention relates to a tool holder for a machine tool, in particular for a hand-held power tool such as a rotary hammer, according to the preamble of claim 1.

### BACKGROUND INFORMATION

DE 10 2004 036 587 A1 describes a receiving device for a hand-held power tool designed as a rotary hammer, the receiving device being designed to receive an insertion tool. The insertion tool is axially insertable into a tool holder designed as a receiving sleeve, in the wall of which an axially extending driving profile is situated such that the insertion tool may be inserted until it reaches a striking pin of the rotary hammer. The insertion tool may therefore be driven in a rotary and/or percussive manner.

To ensure that insertion tools with different designs may be used, e.g., a screwdriver and a drill bit, and to thereby attain a broad spectrum of applications, the aim is to design the tool holder such that insertion tools with different shanks may be used. It must be ensured that every shank will be accommodated in the tool holder in a completely safe manner even though shanks having different designs will be used. It must also be ensured that the hold is absolutely secure, and that the risk that the insertion tool will become tilted in the tool holder is reduced.

### DISCLOSURE OF THE INVENTION

The object of the present invention is to provide an easily-operated tool holder for a machine tool using simple design measures, the tool holder enabling different insertion tools to be used with high operational reliability.

This object is achieved according to the present invention via the features of claim 1. The subclaims describe advantageous refinements.

The locking device of the tool holder according to the present invention includes a locking element, which, with the aid of a blocking element, is displaceable between a release position and a locking position, in which it locks the insertion tool in the tool holder. The blocking element is held in the tool holder in a displaceable manner, and it is acted upon by the insertion tool.

This design offers the advantage that the blocking element is actuated when the insertion tool is inserted into the tool holder, the blocking element being held on the tool holder and being capable of performing a displacement motion relative to the tool holder. The locking element is automatically displaced between the release position and the locking position via the motion of the blocking element. The actuating motion of the blocking element is derived from the motion of inserting the insertion tool into the tool holder, and from the motion to remove the insertion tool from the tool holder.

The locking element expediently performs a radial motion, the locking position and the release position of the locking element being characterized by different radial positions relative to the longitudinal axis of the tool holder. In contrast, the blocking element preferably performs an axial motion when it moves between the locking position and the release position, thereby making it possible to convert the axial insertion motion of the insertion tool into the tool holder directly into the actuating motion of the blocking element.

Expediently, the axial actuating motion of the blocking element is converted to the radial transfer motion of the locking element between the release position and the locking position via a slanted displacement surface on the blocking element, which is advantageously designed as a bevel and forms an angle that is greater than 0° and less than 90° relative to the longitudinal axis of the tool holder. For the case in which the blocking element is preferably designed as a blocking ring or a blocking sleeve, the displacement surface is advantageously designed as an inwardly located conical surface.

The locking element is preferably designed as a locking ball, which may be displaced in the radial direction in a relatively easily manner with the aid of the slanted surface of the blocking element, which is moved axially against the ball.

The blocking element, which is expediently designed as a sleeve, is acted upon with force by an assigned spring element, which bears, in particular, against the tool holder, in particular in the direction of the blocking position. To move the locking element into the locking position, the blocking element is displaced—in a first phase of motion, and with the aid of the insertion tool to be inserted—axially against the force of the spring that acts on it. In a second phase of motion, the blocking element quickly returns—due to the effect of the spring force—in the direction of the blocking position, thereby preventing the locking element—which has since been displaced into the locking position—from moving further.

According to a particularly preferred embodiment, a control element is provided, which is located on the tool holder, displaces the blocking element, and is designed as a control ball in particular. This control element is advantageously retained in the tool holder in such a manner that it is displaceable in the axial and radial directions. In a first phase, the control element is displaced axially by the insertion tool during insertion into the tool holder and thereby carries the blocking element along, which is slid against the force of the spring that acts on it. In this first phase, the control element is located in a control and/or working position, in which the blocking element is acted upon by the control element. As soon as the control element has reached its axial end position in a slot formed in the wall of the tool holder, the control element moves radially—under the influence of the insertion tool, which is inserted further in the axial direction—into a recess formed in the blocking element, thereby sliding the blocking element a bit further in the axial direction. This recess is, in particular, a recess that is formed by the slanted displacement surface on the blocking element. The control element is thereby displaced out of its initial control position assigned to a first phase of motion and into a non-operational position assigned to the second phase. At the same time, the transfer of force between the insertion tool and the blocking element decreases along the control element, thereby enabling the blocking element to return rapidly to the blocking position via the action of the spring. The locking element is advantageously displaced from the release position and into the locking position in the transition from the first phase of motion to the second phase of motion, and it is held in the locking position by the blocking element, which has now assumed its blocking position.

To release the connection and remove the insertion tool from the tool holder, a release sleeve is advantageously provided, which is to be displaced axially against the force of a spring that acts on it. Via this actuating motion, the blocking element is also moved—against the force of the spring acting on it—out of the blocking position and into the release position, thereby also enabling the locking element to be moved out of the locking position and into the release position, thereby enabling the insertion tool to be removed from the tool holder.

Further advantages and advantageous embodiments are depicted in the further claims, the description of the figures, and the drawings.

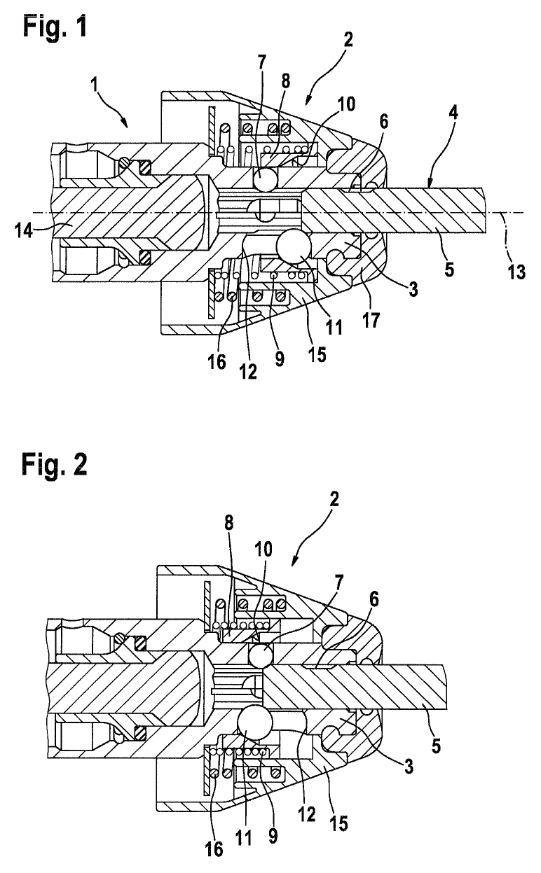

FIG. 1 shows a cross-sectional view through a tool holder for a hand-held power tool, in particular a rotary hammer, shown at the beginning of the insertion of an insertion tool into a tool holder provided for this purpose,

FIG. 2 shows the insertion tool in a position in which it has been inserted further in the axial direction, in which a control ball is displaced axially by the shank of the insertion tool, thereby also axially displacing a blocking sleeve against the force of a spring that acts on it,

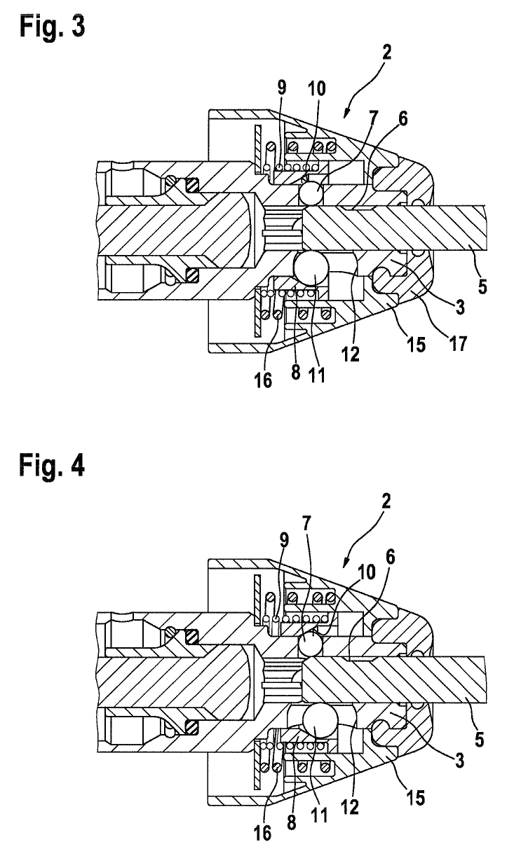

FIG. 3 shows the insertion tool in a position in which it has been inserted further, in which the control ball is pressed by the shank of the insertion tool—when it comes to bear against the rear end of a slot in the tool holder—against a slanted displacement surface on the blocking sleeve, and is moved radially outwardly as the axial displacement continues, a locking ball being moved radially outwardly at the same time by the shank of the insertion tool, out of a release position and into a locking position,

FIG. 4 shows the blocking sleeve in a next phase of motion, in which the blocking sleeve has been returned a bit further in the direction of the blocking position, via the action of its spring,

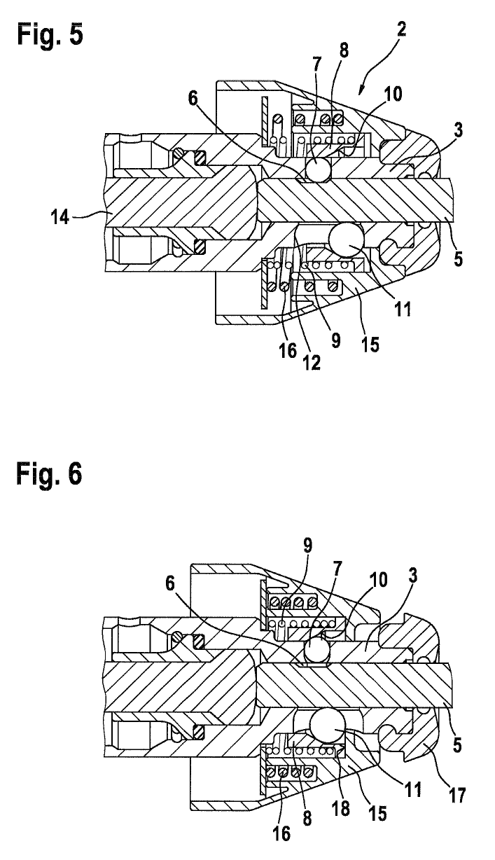

FIG. 5 shows the insertion tool in a locking position, having been slid axially to the furthest point, in which the locking ball is pressed by the blocking element into a recess in the jacket surface of the shank of the insertion tool, and is held in this position,

FIG. 6 shows the tool holder in the release position, in which a release sleeve is slid axially backward against the force of a spring that acts on it, and the blocking element is slid into the release position, thereby enabling the locking ball to be moved out of the locking position and into the release position,

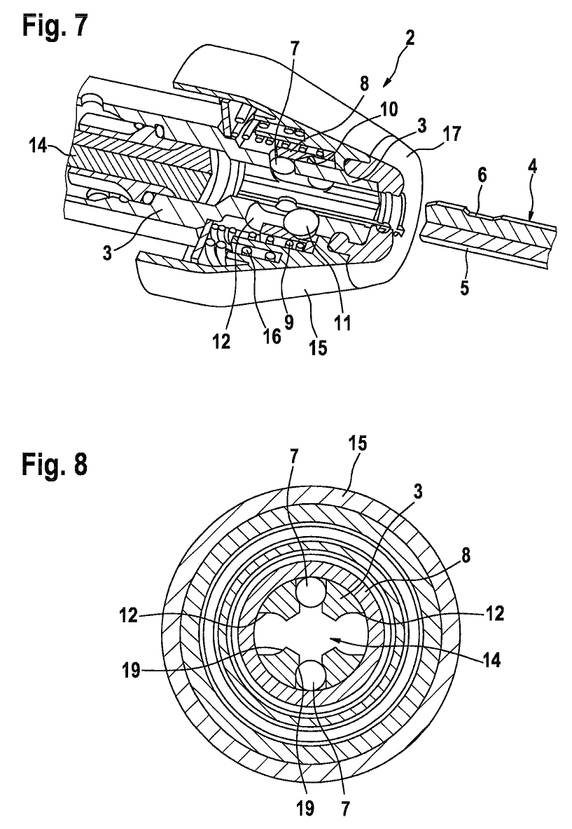

FIG. 7 shows a perspective view of the tool holder in a partial cross section, including the shank of a drill, which is to be inserted in the tool holder,

FIG. 8 shows a cross section of the tool holder.

Components that are the same are labelled with the same reference numerals in the figures.

The hand-held power tool 1 shown in the figures is a rotary hammer in particular. Machine tool 1 includes a tool fitting 2, which includes a sleeve-shaped tool holder 3 for receiving an insertion tool 4, whose shank 5 may be slid axially into the receiving opening in tool holder 3. Insertion tool 4 is a drill bit, in particular, e.g., an SDS drill bit or a HEX-WZ drill bit. A radially indented recess 6 having a limited axial length is formed in the jacket surface of shank 5 of insertion tool 4. The inner jacket of the receptacle in tool holder 3 is adapted to various cross-sectional shapes of shank 5 to be inserted.

A locking element designed as locking ball 7 corresponds with radially indented recess 6 in the jacket surface of shank 5 of insertion tool 4. Locking ball 7 is held in a radially extending bore in the wall of tool holder 3, and it may be displaced radially within this bore. In the locking position (FIG. 5), locking ball 7 engages in recess 6 in shank 5 of insertion tool 4, thereby securing the insertion tool in tool holder 3.

Tool holder 2 also includes a blocking sleeve 8, which is installed on the front section of tool holder 3 and extends radially over locking ball 7. Blocking sleeve 8 is provided with a spring element 9, which applies force to the blocking sleeve 8 in the direction of the end face of the machine tool that faces insertion tool 4; this position of blocking sleeve 8, which is assumed by the blocking sleeve due to the action of spring element 9, is the blocking position of the blocking sleeve. An axial displacement of blocking sleeve 8 against the spring force moves the blocking sleeve into the release position.

Tool holder 2 also includes a control element, which is designed as control ball 11, and which controls the axial actuating motion of blocking sleeve 8 depending on the motion of insertion of shank 5 into the fitting in tool holder 3. Control ball 11 is accommodated in an axially displaceable manner in a slot 12 formed in the wall of tool holder 3. Control ball 11 may also move in the radial direction.

Blocking sleeve 8 also includes a slanted displacement surface 10 on its side that faces the end face of the machine tool, displacement surface 10 forming an angle with longitudinal axis 13 of the machine tool. Slanted displacement surface 10 extends in the circumferential direction of blocking sleeve 8 and therefore has a conical shape. The free cross section expands in the direction toward the axial end face of the machine tool. When blocking sleeve 8 is displaced axially against the force of spring element 9 acting on it, slanted displacement surface 10 moves axially into the region of locking ball 7 and control ball 11, thereby enabling both of the balls to move radially and assume a greater radial distance relative to longitudinal axis 13.

In the part facing away from the free end face of the machine tool, a striking pin 14 is inserted in tool holder 3, which, in the locking position (FIG. 5), has contact with the end face of shank 5 and acts on it. Insertion tool 4 may therefore be driven in a rotary and/or percussive manner when in the inserted and locked state.

In addition, a release sleeve 15 is assigned to tool holder 2. In its locked position, release sleeve 15 is acted upon with force by a spring element 16. Release sleeve 15 is located on tool holder 3 such that it is axially displaceable, and it encloses blocking sleeve 8. A projection of release sleeve 15 is in contact with the end face of blocking sleeve 8. When release sleeve 15 is pushed backward axially against the force of spring element 16 that acts on it, the result—due to the contact with blocking sleeve 8—is that the blocking sleeve is also pushed backward axially against the force of spring element 9 that acts on blocking sleeve 8. In this manner, locking ball 7 may be moved out of the locking position and into the release position, and the insertion tool may be removed from tool holder 3.

A protective cap 17 is installed on the end face of tool holder 3. Protective cap 17 also covers the end face of spring-loaded release sleeve 15, is capable of absorbing the spring forces of spring elements 9 and 16, and bears against the tool holder.

A shank 5 of an insertion tool 4 to be inserted is locked in position as follows. Initially, as shown in FIG. 1, shank 5 of insertion tool 4 is slid axially into the opening in tool holder 3 until the end face comes in contact with control ball 11, which is accommodated in slot 12 in an axially displaceable manner, slot 12 being formed in the wall of tool holder 3. As shank 5 is slid further axially into the opening in tool holder 3, control ball 11 is displaced axially by shank 5, as shown in FIG. 2. Control ball 11 bears—via its side that is opposite to shank 5 in the radial direction—against slanted displacement surface 10 formed in blocking sleeve 8. Due to this contact, an axial displacement of control ball 11 also results in an axial displacement of blocking sleeve 8 against the force of spring element 9 acting on it.

FIG. 2 shows the situation during a first phase of motion, in which blocking sleeve 8 has been axially displaced via control ball 11 to the extent that locking ball 7—which is located in a radial bore in the wall of tool holder 3—is located in the region with slanted displacement surface 10. This makes it possible for locking ball 7 to move radially outwardly, which is not possible in the situation shown in FIG. 1, since, in that case, the inner wall of blocking sleeve 8 is in direct contact with locking ball 7, which therefore extends completely into the bore in the wall of tool holder 3.

FIG. 3 shows the point of reversal of the motion of blocking sleeve 8. Control ball 11 bears axially in the stop position against the end face of slot 12 that faces the striking pin. As shank 5 is inserted further in the axial direction, control ball 11 must move radially downward along slanted displacement surface 10 (along the rear edge of the slot) until control ball 11 has left the trajectory of shank 5 entirely. Blocking sleeve 8 thereby moves a bit further axially against spring element 9.

At the same time, locking ball 7 is also displaced radially outwardly by shank 5, which is possible due to the positioning of slanted displacement surface 10 at the level of locking ball 7.

The second phase of motion of blocking sleeve 7 begins in the situation shown in FIG. 3, in which the blocking sleeve is displaced axially by the force of spring element 9 back in the direction of the blocking position. As shown in FIG. 3 in conjunction with FIG. 4, the blocking sleeve moves—due to the action of spring element 9—a bit further in the direction of its blocking position as soon as control ball 11 has moved radially out of the trajectory of shank 5. This displacement motion in the direction of the blocking position is stopped by locking ball 7, against which slanted displacement surface 10 on blocking sleeve 8 comes to bear.

The locking position is shown in FIG. 5, in which shank 5 has been slid fully into the receptacle in tool holder 3, and the free end face of shank 5 is in contact with striking pin 14. In this axial position of shank 5, recess 6 in the jacket surface of the shank is located axially at the level of locking ball 7. Locking ball 7 is displaced radially inwardly until it comes in contact with the wall in recess 6 via the force exerted on it by spring element 9 and blocking sleeve 8 and slanted displacement surface 10 on the blocking sleeve. A minimal amount of radial play between the insertion tool and blocking sleeve 8 is required. At the same time, blocking sleeve 8 may be displaced axially further via the action of spring 9 that acts on it, until it reaches the blocking position, in which displacement surface 10 is located outside of locking ball 7. As a result, locking ball 7 is fixed in position radially by the inner wall of blocking sleeve 8 and is unable to move radially outwardly. Locking ball 7 is therefore located in a captive position in recess 6 of shank 5, thereby securing the insertion tool in the tool holder.

Control ball 11 continues to bear against the slanted displacement surface of blocking sleeve 8. Due to the axial displaceability of control ball 11 in recess 12 formed in the wall of tool holder 3, control ball 11 may perform the actuating motion of blocking sleeve 8 until the blocking position is reached.

FIG. 6 shows the release position, in which shank 5 of the insertion tool may be removed from the receptacle in tool holder 3. To release, release sleeve 15 is pushed backward axially against the force of spring element 16 acting on it. As a result, an inwardly located projection 18 in release sleeve 15 comes in contact with the end face—that faces protective cap 17—of blocking sleeve 8, and moves it axially against the force of spring element 9 until slanted displacement surface 10 of blocking sleeve 8 moves axially into the region of locking ball 7, thereby enabling locking ball 7 to move radially outwardly. As soon as shank 5 is slid backward, locking ball 7 is moved into this radially outwardly displaced position, and shank 5 may be removed.

As shown in FIGS. 7 and 8, a plurality of locking balls 7 and control balls 11 may be provided around the circumference. In the exemplary embodiment shown, two locking balls 7 and two control balls 11 are provided, in which case two locking balls are offset by 180° relative to each other, and the control balls are also offset by 180° relative to each other, the locking balls and control balls being offset by 90° relative to each other, however.

The inner jacket of the receptacle of tool holder 3 may include inner surfaces, which are situated relative to each other at various angles. Axially extending grooves may also be provided in the inner jacket. These various surfaces and grooves make it possible to accommodate various insertion tools having shanks of various designs.

FIG. 8 shows that the radially extending bores in the wall of tool holder 3—in which locking balls 7 are inserted, and slots 12, which are also formed in the wall of tool holder 3, and which are designed to receive control balls 11—have a radially inwardly extending taper 19, in order to prevent locking balls 8 and/or control balls 11 from slipping radially into the axial inner space, which is designed to accommodate shank 5.

1-17. (canceled)

18. A tool holder for a machine tool, comprising a tool holder element in which an insertion tool is insertable and lockable; a locking device for locking the insertion tool in said tool holder element and including a locking element displaceable between a release position and a locking position in which the insertion tool is locked in the tool holder; a blocking element held in said tool holder element and displaceable by the insertion tool, said blocking element inhibiting a motion of said locking element in the locking position; a control element which displaces said blocking element and is located on the tool holder, which, in a first phase, when said control element moves between said release position and said locking position, it is in a control position in which it acts on said blocking element, and, in a second phase, said control element is in a non-operational position, said control element being configured so that it performs an axial motion in the control position and it performs a radial motion to move into a non-operational position.

19. A tool holder for a machine tool as defined in claim 18, wherein said locking element is configured so that it performs a radial motion when it is moved between the locking position and the release position.

20. A tool holder for a machine tool as defined in claim 18, wherein said blocking element is configured so that it performs an axial motion when it is moved between a blocking position and a release position.

21. A tool holder for a machine tool as defined in claim 18, wherein said blocking element includes a slanted displacement surface, against which said locking element comes to bear to move between the locking position and the release position.

22. A tool holder for a machine tool as defined in claim 18, wherein said locking element is configured as a locking ball.

23. A tool holder for a machine tool as defined in claim 18, wherein said blocking element is configured as a blocking sleeve.

24. A tool holder for a machine tool as defined in claim 18, further comprising a spring element have a force acting on said blocking element in a blocking position, said blocking element being displaceable by the insertion tool against the force of said spring element when it is inserted in the tool holder.

25. A tool holder for a machine tool as defined in claim 18, wherein said control element is controllable via a motion of inserting the insertion tool into the tool holder.

26. A tool holder for a machine tool as defined in claim 18, wherein the control element is configured so that to perform a radial motion it comes to bear against a slanted displacement surface of said blocking element.

27. A tool holder for a machine tool as defined in claim 18, wherein said control element is formed so that it comes to bear against an end face of an axially extending slot formed in a wall of said tool holder.

28. A tool holder for a machine tool as defined in claim 18, wherein in said second phase said locking element is displaceable into a position in which said locking element is locked in position.

29. A tool holder for a machine tool as defined in claim 18, wherein said control element is configured as a control bolt.

30. A tool holder for a machine tool as defined in claim 18, wherein the tool holder is provided for the machine tool which is configured as a hand-held power tool.

31. A tool holder for a machine tool as defined in claim 18, wherein the tool holder is configured for the machine tool which is a hand-held rotary hammer.
